(19) United States
(12) Patent Application Publication
(10) Pub. No.: US 2018/0106155 A1
(43) Pub. Date: Apr. 19, 2018

(54) TRANSITION DUCT FORMED OF A PLURALITY OF SEGMENTS

(71) Applicant: Siemens Energy, Inc., Orlando, FL (US)

(72) Inventor: Anthony L. Schiavo, Oviedo, FL (US)

(21) Appl. No.: 15/292,390

(22) Filed: Oct. 13, 2016

(51) Int. Cl. F01D 9/02; F23R 3/00

(52) U.S. Cl. CPC F01D 9/023; F05D 2220/32; F23R 3/002

(57) ABSTRACT

A gas turbine engine having a transition duct made of a plurality of segments. Each of the segments is connected to an adjacent segment. The plurality of segments may be made of ceramic material or super alloys.

### STATEMENT REGARDING FEDERALLY SPONSORED DEVELOPMENT

This invention was made with government support under Program DE-FE0023955, awarded by the United States Department of Energy. The government has certain rights in the invention.

### BACKGROUND

### 1. Field

Disclosed embodiments are generally related to gas turbine engines and, more particularly to a transition system used in gas turbine engines.

### 2. Description of the Related Art

A gas turbine engine typically has a compressor section, a combustion section having a number of combustors and a turbine section. Ambient air is compressed in the compressor section and conveyed to the combustors in the combustion section. The combustors combine the compressed air with a fuel and ignite the mixture creating combustion products. The combustion products flow in a turbulent manner and at a high velocity. The combustion products are routed to the turbine section via transition ducts. Within the turbine section are rows of vane assemblies. Rotating blade assemblies are coupled to a turbine rotor. As the combustion product expands through the turbine section, the combustion product causes the blade assemblies and turbine rotor to rotate. The turbine rotor may be linked to an electric generator and used to generate electricity.

During the operation of gas turbine engines strong forces are generated that can impact the structure of the gas turbine engine. These forces may occur in the transition duct. Accommodating these forces to avoid breakage is important for the continued operation of the gas turbine engine.

### SUMMARY

Briefly described, aspects of the present disclosure relate to transition ducts of gas turbine engines.

An aspect of the disclosure may be a gas turbine engine having a combustor for producing combustion products. The gas turbine engine may also have a transition duct connected to the combustor, wherein the transition duct is formed from a plurality of segments, wherein each of the segments has a bottom portion extending in an axial direction with respect to the gas turbine engine, wherein each of the segments additionally has two sidewalls extending orthogonally in a radial direction from the bottom portion, wherein each of the two sidewalls is connected to an adjacent segment, wherein the combustion products flow downstream through the transition duct; and an inlet extension piece connected to the transition duct, wherein the combustion products flow from the transition duct through the inlet extension piece.

Another aspect of the invention may be a transition duct for a gas turbine engine having a plurality of segments, wherein each of the segments has a bottom portion extending in an axial direction with respect to the gas turbine engine when assembled, wherein each of the segments additionally has two sidewalls extending orthogonally in a radial direction from the bottom portion, wherein each of the two sidewalls is connected to adjacent sidewalls of another segment.

### BRIEF DESCRIPTION OF THE DRAWINGS

FIG. 1 shows a cross sectional view through a portion of a gas turbine engine.

FIG. 2 shows a view of gas turbine engine using a transition duct with segments

FIG. 3 is a view of the transition duct formed with segments.

FIG. 4 is a view of a segment that forms the transition duct.

FIG. 5 is a view of the transition duct formed with segments having an inlet ring assembly with struts attached.

FIG. 6 shows the attachment of the segment to the integrated exit piece (IEP).

FIG. 7 shows the attachment of the inlet ring assembly to the segment.

FIG. 8 shows an alternative embodiment of a transition duct formed with segments.

FIG. 9 shows another alternative embodiment of a transition duct formed with segments.

### DETAILED DESCRIPTION

The present inventor has recognized that some turbine engines have transition systems that use transition ducts that are made of metal. The metal transition ducts become subjected to powerful forces during the operation of gas turbine engines. Recognizing the impact that these forces have on the transition ducts, the inventor has determined that constructing the transition duct out of a material that performs well under intense pressures in heat would be desirable for this component. These types of materials are certain types of alloys and ceramics.

However using these materials pose other problems when implemented in the gas turbine engine. Forming the transition duct into a unitary component made of ceramic can be difficult to manufacture and can suffer issues related stresses cause be the heat and operation of the gas turbine engine. The inventor has recognized that forming a the transition duct out of a plurality of individual segments can provide both the benefit of behaving well in extreme temperatures as well as being able to accommodate the intense forces that can occur during operation of the gas turbine engines.

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure. However, in some instances where the specific features of the materials used in the embodiments are called out, it should be understood that those particular materials are intended for use the embodiments disclosed herein.

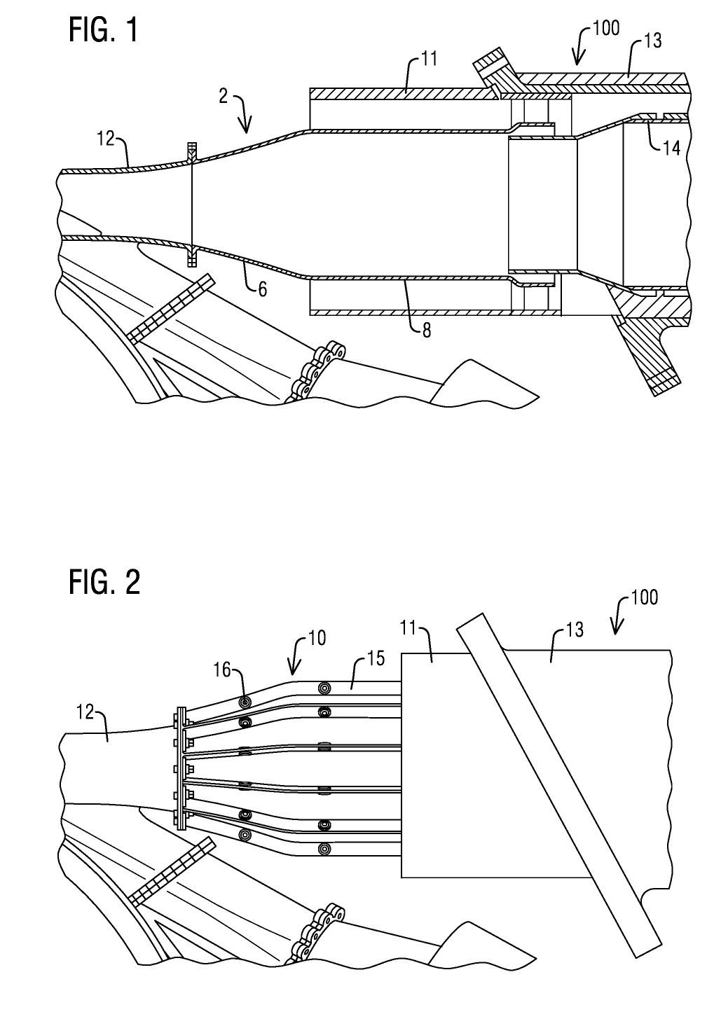

In the figures like reference numerals are used to reference like components throughout the figures. FIG. 1 is a view of a gas turbine engine 100. The gas turbine engine 100 has a combustion basket 14 in which combustion occurs. The combustion basket 14 is surrounded by a spool piece 13. Combustion occurs in the combustion basket 14 and combustion products flow downstream into the transition system 2. The transition system 2 is surrounded by a flow sleeve 11. The transition system 2 has a cylindrical duct 8 and a conical duct 6. From the transition system 2 the combustion products flow into the integrated exit piece (IEP) 12.

In the gas turbine engine 100 shown in FIG. 1, the cylindrical duct 8 and the conical duct 6 of the transition system 2 are made of metallic material. Generally speaking, having the transition system 2 made of metallic material requires single casting of the pieces. The single casting of the pieces limits the shape, construction and durability of the components. Being able to construct the components of the transition system 2 from better materials such as ceramics or super alloys permits construction of a more durable transition system. Ceramic matrix composites may be made from Nextel 610 or 720 woven fabrics. Superalloy materials may be Haynes 282, Inconel 617, Haynes 188, etc.

FIG. 2 shows a view of gas turbine engine 100 using a transition duct 10 that is formed with a plurality of segments 15. Each of the plurality of segments 15 may be made from a ceramic material or a super alloy. In the embodiment shown in FIG. 2 the segments 15 are made from a ceramic material. The ceramic material is able to withstand the effects of temperature better than metallic materials. When the segments 15 are made of ceramics they may be comprised of a plurality of ceramic layers.

Each of the segments 15 are clamped to other segments 15 using binding posts 16. The bounded together segments 15 form the transition duct 10. Each of the segments 15 extend axially downstream lengthwise. As shown in FIG. 2 the formed transition duct 10 is comprised of a plurality of segments 15 that form a conical and cylindrical shaped transition duct 10. In addition to being formed from a plurality of segments 15, the transition duct 10 may also have a reduction in length. Having a reduction in length can reduce the surface are of the transition duct 10 that needs to b cooled. Furthermore, the reduction in length also results in a reduction of the amount of material that is being used and thereby results in cost savings.

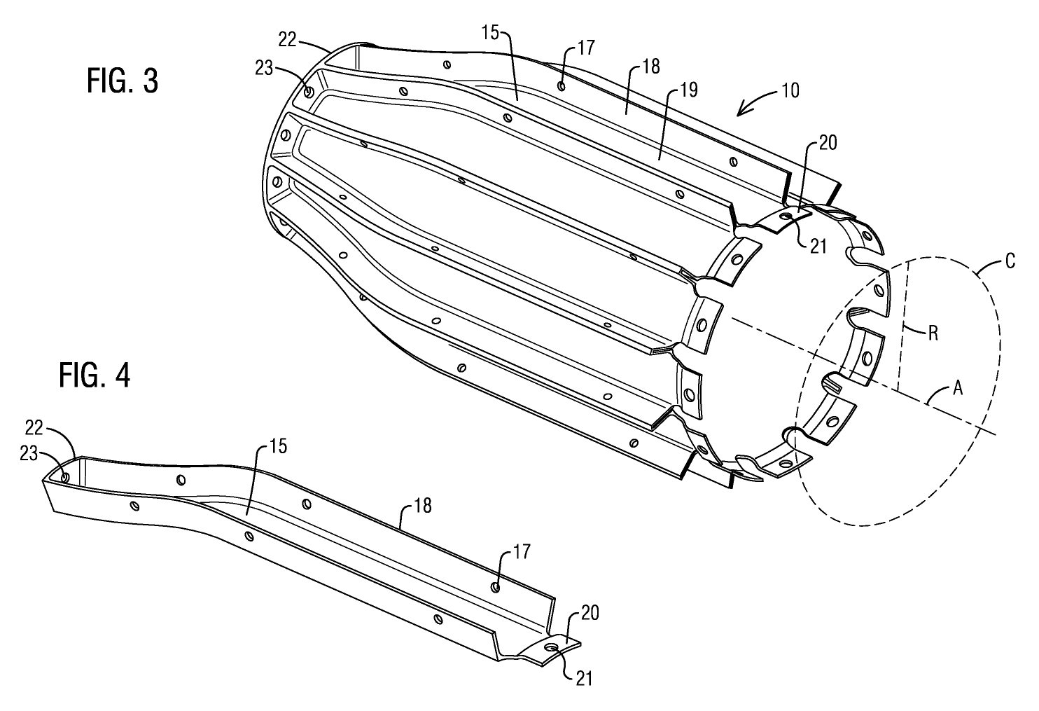

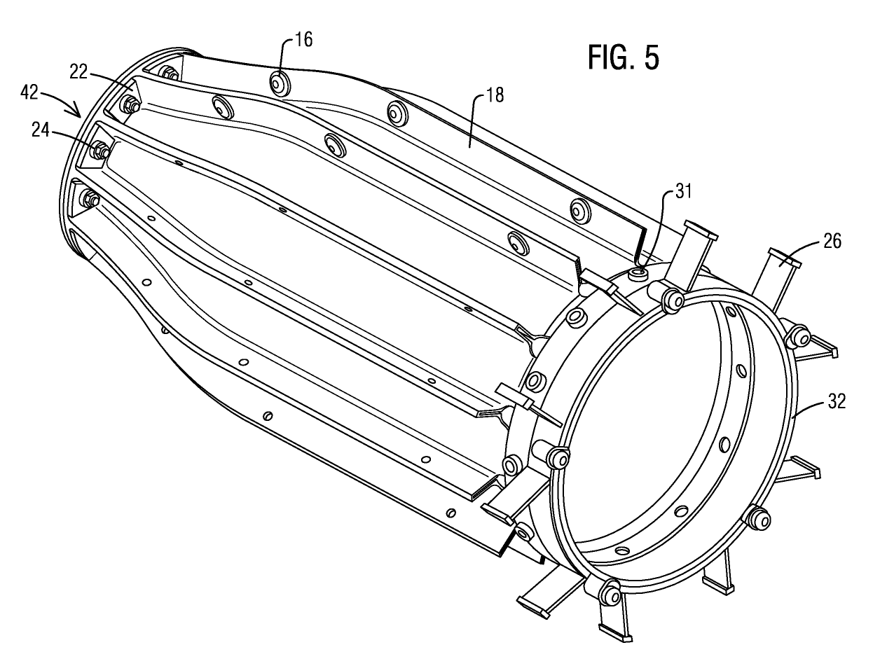

FIGS. 3-5 show views of the transition duct 10 and the segments 15 that form the transition duct 10. FIG. 3 shows the axial direction A, circumferential direction C and radial direction R that are used for reference throughout this application. As shown, there are twelve segments 15 that used in the construction of the transition duct 10. It should be understood that more or less than twelve segments 15 may be used and the implementation of the segments 15 in the formation of the transition duct 10 is not limited to the embodiments disclosed herein.

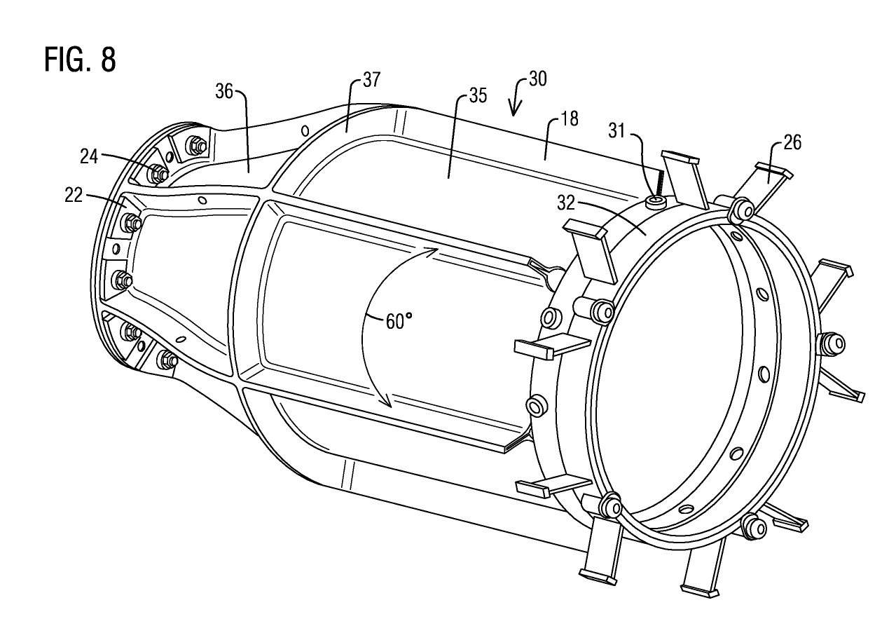

In the embodiment shown in FIGS. 3-5 each segment 15 has an arc length of 30°. It should also be understood that while each segment 15 shown in FIGS. 3-5 is formed so as to be identical to each other, it is possible to have differently sized segments 15 used in order to form the transition duct 10. So for example, the segments 15 may have an arc length of 30°, while additional segments may have arc lengths of 15°, this could result in a transition duct 10 having six segments 15 having an arc length of 30° and twelve segments having an arc length of 15°. Differently size segments 15 can prove beneficial for optimizing the in mid-frame environments. The arrangement can translate into changing wall thicknesses on the cold side so as to increase the mechanical integrity of the transition duct 10 at the location where the discharge from the compressor section impinges and cools the transition duct 10 and further have the leeward side have thinner walls which can increase the cooling effectiveness with reduced impingement. Other variations may be employed in addition to these two examples and a further example is provided below in reference to FIG. 8, wherein larger segments 35 and 36 are employed in the formation of a transition duct 30.

Each segment 15 extends axially lengthwise downstream from an inlet flange 20 to an outlet flange 22. Each segment 15 has a bottom portion 19 and two sidewalls 18. The elongated pan shape of each segment 15 is able to provide a flow guide for air moving through the system. Additionally the use of the segments 15 is able to provide improved structural integrity when assembled to form the transition duct 10. Each outlet flange 22 is arced. The plurality of arced outlet flanges 22 in conjunction with the sidewalls 18 forms an annular flange 42 when the transition duct 10 is assembled that provides improved structural integrity. The assembled segments 15 may also experience different thermal effects during the operation due to not being formed as a unitary piece. In other words the heating or cooling of each segment 15 impacts the transition duct 10 in a different manner than a uniformly formed transition duct.

The inlet flange 20 extends axially in an upstream direction with respect to the segment 15. Formed in the inlet flange 20 is a bolt hole 21 which receives bolt 31. Bolt hole 21 and bolt 31 secures inlet ring assembly 32 to the transition duct 10. Inlet ring assembly 32 additionally has struts 26 formed thereon that extend circumferentially around the inlet ring assembly 32. The struts 26 contact and interact with the flow sleeve 11 when installed.

Each sidewall 18 extends orthogonally radially outwards from the bottom portion 19 and runs the length of the segment 15 from the inlet flange 20 to the outlet flange 22. The segment 15 is shaped so as to form both a cylindrical portion and conical portion of the transition duct 10. In order to accomplish this, the segment 15 bends radially inward as it approaches the IEP 12. Located within the sidewalls 18 are binder post holes 17. The binder post holes 17 receive binders 16. The binder post holes 17 and binders 16 may be threaded binder hardware. Binder screw thread end and threaded binder washer exit thread may be tack welded to provide anti-rotation. Additionally, the segments could be bound together using unthreaded binders and rivets. When assembled the sidewall 18 of one segment 15 is secured to an adjacent sidewall 18 of another segment 15. There can be a plurality of binder post holes 17 and binders 16 used in assembling and forming the transition duct 10. Connecting a plurality of segments 15 in this manner permits the transition duct 10 to be made from material that is more resistant to heat. Furthermore, the transition duct 10 is able to accommodate the various forces that occur during the operation of the gas turbine engine 100 because of the individual movements that each segment 15 can accommodate. Additionally, in the event that the segment 15 needs to be repaired, an individual segment 15 may be replaced instead of the entire transition duct 10. Replacement of an individual segment 15 can accommodate uneven degradation of a portion of the transition duct 10 without replacing the entire transition duct 10.

The outlet flange 22 extends orthogonally radially outwards from the bottom portion 19 of the segment 15. The outlet flange 22 is used to connect the segment 15 to the IEP 12. This is accomplished via the bolt hole 23 and a bolt 24. Once assembled with the other outlet flanges 22 the assembled structure provides good structural integrity that may be improved over other existing transition ducts.

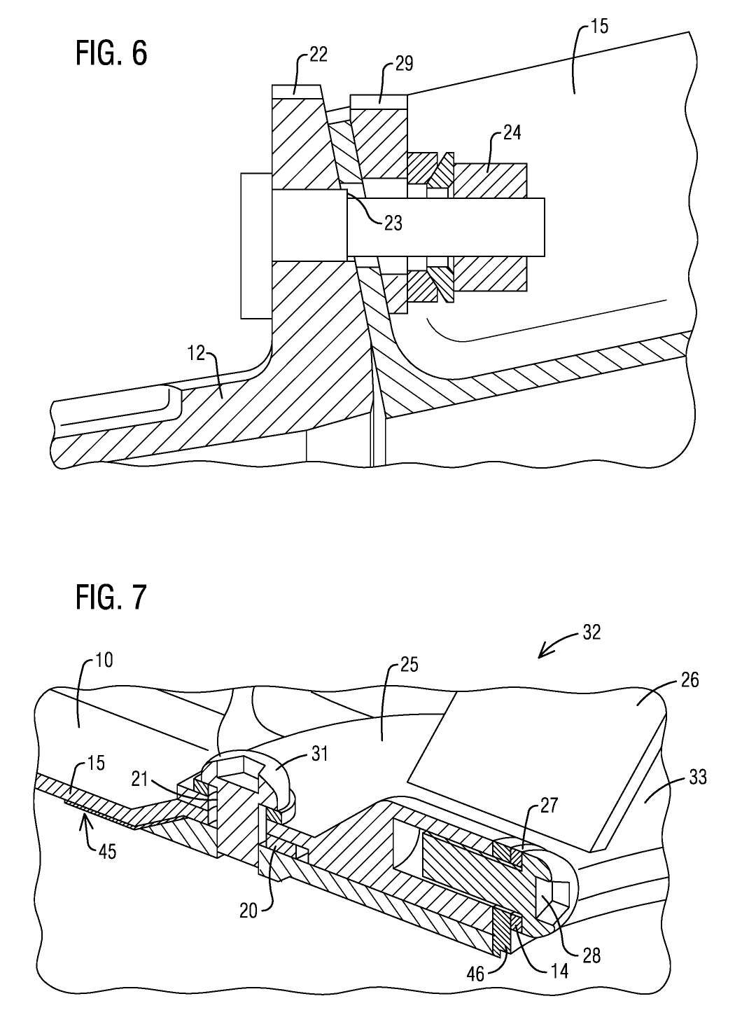

FIG. 6 shows the attachment of the segment 15 to the IEP 12. The connection of the segment 15 to the outer flange 22 via bolt 23 and bolt hole 24 uses a spherical clamp block 29. The outer flange 22 is a spherical flange. The outer flange 22 is angled axially downstream as it extends radially outwards. The spherical clamp block 29 complements the slope of the outer flange 22 and permits a smooth assembly of the segment 15 to the IEP 12. The outer flange 22 and the spherical clamp block 29 allows slight swivelling that may occur due to incompatible interfaces that occur during engine installation. Although the outer flange 22 and the spherical clamp block 29 are used in order to accommodate a spherical flange arrangement, it should be understood that alternatively a flat flange arrangement could be used.

FIG. 7 shows the attachment of the inlet ring assembly 32 to the segment 15. The inlet ring assembly 32 is an assembly configured with an outer clamp ring 33, a protector ring 45, an inner clamp ring 25, an eccentric washer 46 and a multitude of fasteners. The inner clamp ring 25 provides a landing surface for the combustor. The inner clamp ring material is preferably selected to match the material of the combustor spring clips. The inner clamp ring 25 may also have a plurality of cooling features. Cooling ejection holes may mitigate recirculation and ingestion of hot gas. The ejection holes can purge the gap between the combustor and inner surface of the transition duct. Additionally ejection holes can lay down a cool film boundary protecting the inlet flange 20 and protector ring 45. The outer clamp ring 33 is the backbone of the inlet ring assembly 32 and provides rigidity to the inlet ring assembly 32, while supporting the transition duct 10 and combustor in the flow sleeve. The material of the outer clamp ring 33 can be chosen to suit the mechanical needs at the interfaces of the struts. Formed in the inlet flange 20 is a bolt hole 21 which receives bolt 31. The inlet flange 20 is bent so as to support the inlet of the transition duct 10 with the inlet ring assembly 32. Bolt hole 21 and bolt 31 secures inlet ring assembly 32 to the transition duct 10. Further through the inlet ring assembly 32 is a bolt hole 27 through which a bolt 28 is inserted. The insertion of the bolt 28 into the bolt hole 27 secures the inlet ring assembly 32 and compresses the protector ring 45 on to the segment 15.

There also may be a protector ring 45 that is spring loaded to bias the transition duct 10 against the inlet ring assembly 32. The protector ring 45 may protect the end fibers and supports the inlet flange 20. The protector ring 45 also compresses ceramic fiber ends uniformly while constraining the transition duct 10 during thermal transients. Additionally an eccentric washer 46 may be used to axially position components of the transition duct 10 together in a sub-assembly.

FIG. 8 shows an alternative embodiment of a transition duct 30 formed with segments 35 and segments 36. Segments 35 are cylindrical segments, while segments 36 are conical segments. In the embodiment shown segment 35 has an arc length of 60°. The segment 35 extends in an axial direction from the inlet ring assembly 32 to a transition support wall 37. When assembled with other segments 35 a cylindrical shape is formed for part of the transition duct 30. Segments 36 slope radially inwardly as they extend downstream from the transition support wall 37 to the IEP 12. The sloping of segments 36 when assembled with other segments 36 form a conical portion of the transition duct 30.

The larger arc length of the segments 35 results in the use of the additional segments 36 in order to provide additional support for transition duct 30 when assembled. Between the segment 35 and the segment 36 is a transition support wall 37. The transition support wall 37 provides further structural support for the segment 36 and segment 35. The transition support wall 37 extends in a circumferential direction between the two side walls 18 and separates segments 35 from segments 36.

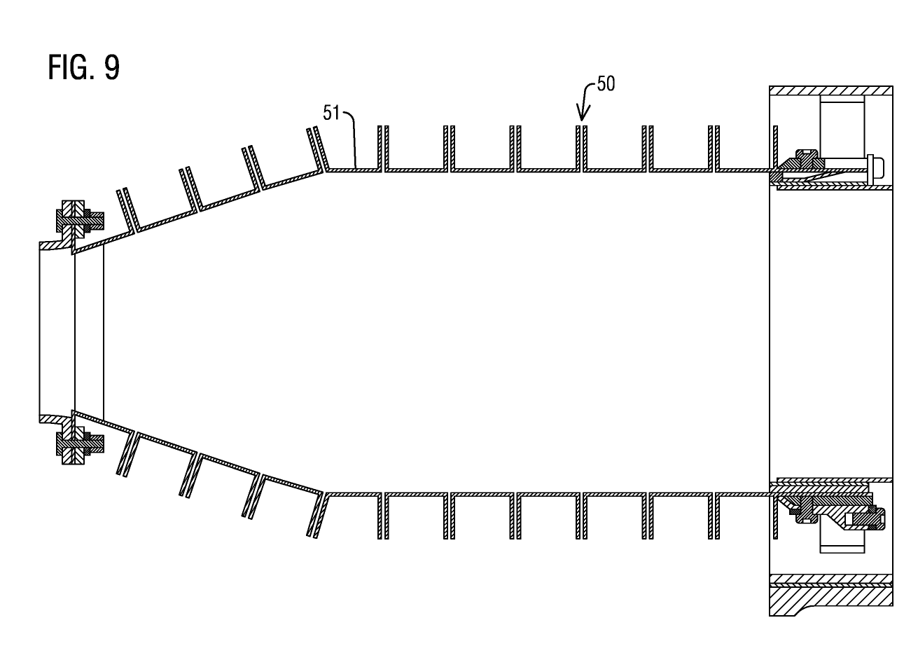

FIG. 9 shows an alternative embodiment of a transition duct 50. In this embodiment the segments 51 do not extend in an axial direction and instead extend circumferentially around the axis of the transition duct 50. This arrangement further provides the benefits of structural integrity obtained by using a plurality of segments 51 as opposed to forming the transition duct 50 as a single unitary piece.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A gas turbine engine comprising:
a combustor for producing combustion products;
a transition duct connected to the combustor, wherein the transition duct is formed from a plurality of segments, wherein each of the segments has a bottom portion extending in an axial direction with respect to the gas turbine engine, wherein each of the segments additionally has two sidewalls extending orthogonally in a radial direction from the bottom portion, wherein each of the two sidewalls is connected to an adjacent segment, wherein the combustion products flow downstream through the transition duct; and
an inlet extension piece connected to the transition duct, wherein the combustion products flow from the transition duct through the inlet extension piece.

2. The gas turbine engine of claim 1 wherein each segment of the transition duct is made of ceramic material or a super alloy.

3. The gas turbine engine of claim 1, wherein each segment has an arc length of 30 degrees.

4. The gas turbine engine of claim 1, wherein each segment has an arc length of 60 degrees.

5. The gas turbine engine of claim 4, further comprising a second plurality of segments, wherein the second plurality of segments forms a conical portion of the transition duct.

6. The gas turbine engine of claim 5, further comprising an end wall located between each of the plurality of segments and each of the second plurality of segments.

7. The gas turbine engine of claim 1, wherein the plurality of segments forms both a cylindrical portion of the transition duct and a conical portion of the transition duct.

8. The gas turbine engine of claim 1, wherein each sidewall has a plurality of binder holes, wherein each of the plurality of binder holes has received therein a threaded binder post.

9. The gas turbine engine of claim 1, wherein the plurality of segments is connected to the integrated exit piece using a spherical flange assembly.

10. The gas turbine engine of claim 1, wherein the plurality of segments is connected to an inlet ring assembly.

11. The gas turbine engine of claim 1, wherein each of the plurality of segments has an outer flange that is located proximate to the inlet extension piece, wherein the outer flanges and the sidewalls form an annular flange.

12. A transition duct for a gas turbine engine comprising:
a plurality of segments, wherein each of the segments has a bottom portion extending in an axial direction with respect to the gas turbine engine when assembled, wherein each of the segments additionally has two sidewalls extending orthogonally in a radial direction from the bottom portion, wherein each of the two sidewalls is connected to adjacent sidewalls of another segment.

13. The transition duct of claim 12, wherein each of the plurality of segments is made of ceramic material or a super alloy.

14. The transition duct of claim 12, wherein each segment has an arc length of 30 degrees.

15. The transition duct of claim 12, wherein each segment has an arc length of 60 degrees.

16. The transition duct of claim 15, further comprising a second plurality of segments, wherein the second plurality of segments forms a conical portion of the transition duct.

17. The transition duct of claim 16, further comprising an end wall located between each of the plurality of segments and each of the second plurality of segments.

18. The transition duct of claim 12, wherein the plurality of segments forms both a cylindrical portion of the transition duct and a conical portion of the transition duct.

19. The transition duct of claim 12, wherein each sidewall has a plurality of binder holes, wherein each of the plurality of binder holes has received therein a threaded binder post.

20. The transition duct of claim 11, wherein each of the plurality of segments has an outer flange that is located proximate to the inlet extension piece, wherein the outer flanges and the sidewalls form an annular flange.
